(19) United States
(12) Patent Application Publication
(10) Pub. No.: US 2014/0188912 A1
(43) Pub. Date: Jul. 3, 2014

(54) STORAGE APPARATUS, CONTROL METHOD, AND COMPUTER PRODUCT

(71) Applicant: FUJITSU LIMITED, Kawasaki-shi (JP)

(72) Inventors: Takashi Watanabe, Kawasaki (JP); Yoshihiro Tsuchiya, Yokohama (JP); Yasuo Noguchi, Kawasaki (JP)

(73) Assignee: FUJITSU LIMITED, Kawasaki-shi (JP)

(21) Appl. No.: 14/073,196

(22) Filed: Nov. 6, 2013

(30) Foreign Application Priority Data
Dec. 28, 2012 (JP) 2012-289113

(51) Int. Cl. G06F 7/24

(52) U.S. Cl. CPC G06F 7/24
USPC 707/754

(57) ABSTRACT

A storage apparatus includes a storing unit that stores a Bloom filter in which data characteristic values are registered, the data characteristic values extracting properties of data that are stored in areas into which a storage area is divided; and a processor that is configured to judge whether a first data characteristic value extracting a property of a first data that is to be written into the storage area is registered in the Bloom filter, and write the first data into the storage area, when the first data characteristic value is not registered in the Bloom filter.

### CROSS REFERENCE TO RELATED APPLICATIONS

This application is based upon and claims the benefit of priority of the prior Japanese Patent Application No. 2012-289113, filed on Dec. 28, 2012, the entire contents of which are incorporated herein by reference.

### FIELD

The embodiment discussed herein is related to a storage apparatus, a control method, and a computer product.

### BACKGROUND

Conventionally, there has been a bit string data structure called a Bloom Filter. The Bloom filter is used when efficient determination of whether given data is included in an existing data set is performed. According to a related technology, if a first bit string corresponding to a first section to be identified by a search value and range information does not satisfy a generation condition, then input data is registered in the first bit string and, if the first bit string satisfies the generation condition, then the range information and a second bit string of a second section are generated. There is a technology in which in a system of database peers hierarchically connected, a given device has for each lower-layer device, a bit string that indicates the presence of a file set managed by the device of a layer lower than that of the given device; the given device further has a bit string indicating the presence of a file set managed thereby (see, for example, Japanese Laid-Open Patent Publication Nos. 2010-266952 and 2008-102795).

According to the conventional technologies, however, when redundancy determination of determining whether data of the same contents as given data is in an existing data set is performed using a Bloom filter, the load of the redundancy determination increases as the number of Bloom filters increases.

### SUMMARY

According to an aspect of an embodiment, a storage apparatus includes a storing unit that stores a Bloom filter in which data characteristic values are registered, the data characteristic values extracting properties of data that are stored in areas into which a storage area is divided; and a processor that is configured to judge whether a first data characteristic value extracting a property of a first data that is to be written into the storage area is registered in the Bloom filter, and write the first data into the storage area, when the first data characteristic value is not registered in the Bloom filter.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an operation example of a storage apparatus according to an embodiment;

FIG. 2 is an explanatory diagram of a connection example of a storage system;

FIG. 3 is a block diagram of a hardware configuration of the storage apparatus;

FIGS. 4A and 4B are explanatory diagrams of one example of the contents of a multi-Bloom filter (MBF);

FIGS. 5A and 5B are explanatory diagrams of one example of storing bits of the MBF after transposition;

FIG. 6 is a block diagram of an example of functions of the storage apparatus;

FIG. 7 is an explanatory diagram of one example of the contents of a block map table;

FIG. 8A is an explanatory diagram of one example of the contents of a writing object MBF cache;

FIG. 8B is an explanatory diagram of one example of the contents of an MBF cache table;

FIG. 8C is an explanatory diagram of one example of the contents of an MBF table;

FIG. 9 is an explanatory diagram of one example of contents of a hash log table;

FIGS. 10A and 10B are explanatory diagrams of an operation example of a reading process;

FIGS. 11A and 11B are explanatory diagrams of an operation example of the reading process;

FIG. 12 is an explanatory diagram of an operation example of a writing process;

FIG. 13 is an explanatory diagram of an operation example of the writing process;

FIG. 14 is a flowchart of one example of a procedure of the reading process;

FIG. 15 is a flowchart of an example of a procedure of the writing process;

FIG. 16 is another flowchart of the example of the procedure of the writing process;

FIG. 17 is an explanatory diagram of the relationship between storage capacity of memory and cache hit rate; and

FIG. 18 is an explanatory diagram of a performance comparison at the time of reading.

### DESCRIPTION OF EMBODIMENTS

Embodiments of a storage apparatus, a control method, and a control program will be described in detail with reference to the accompanying drawings.

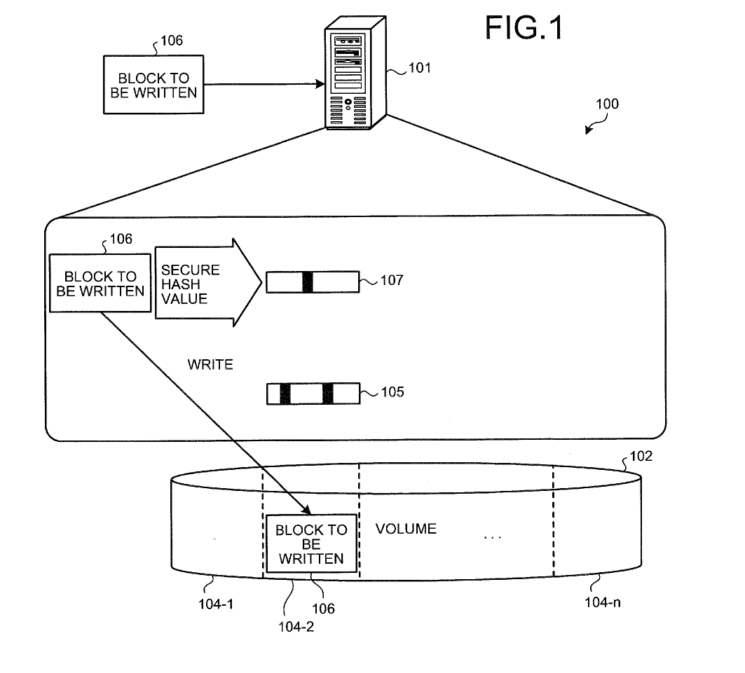

FIG. 1 is an explanatory diagram of an operation example of a storage apparatus according to an embodiment. A storage apparatus 101 included in a storage system 100 is a computer that controls a volume 102 that stores data. The storage system 100 is a system that provides a storage area of the volume 102 to a user of the storage system 100. The storage apparatus 101 may directly read and/or write the data of the volume 102, and may control the volume 102 and send reading and writing instructions to the volume 102.

For example, the storage system 100 is accessed by a Web server to store Web contents that are to be provided by the Web server to the user. For example, the storage system 100 stores a file to be used by the user.

To suppress the amount of storage of the volume 102, the storage apparatus 101 executes a deduplication technique. The storage apparatus 101, which executes the deduplication technique, performs the following processing with respect to a writing process and a reading process.

With respect to the writing process, the storage apparatus 101 divides the data to be written into blocks. The storage apparatus 101 then calculates for extracted properties of the blocks, data characteristic values that express the characteristics as a specific value. The data characteristic value is, for example, a secure hash value that makes alteration of a block is difficult without alteration of the data characteristic value. As for an algorithm to calculate the secure hash value, there are a message-digest 5 (MD5), a secure hash algorithm (SHA)-1, an SHA-256, etc. Hereinafter, description will be made on the assumption that the data characteristic value is the secure hash value.

The storage apparatus 101 compares the calculated secure hash value and a secure hash value of the block already stored in the volume 102 to judge whether the data is existing data or new data. If the data is existing data, the storage apparatus 101 performs deduplication by not writing the block into the volume 102. If the data is new data, the storage apparatus 101 assigns a physical address of a writing destination within the volume 102 and writes the block thereto. The storage apparatus 101 correlates and adds the calculated secure hash value and the assigned physical address to an index that is for searching for the physical address from the secure hash value. The storage apparatus 101 correlates and stores a logical address and the secure hash value to a correspondence table.

With respect to the reading process, the storage apparatus 101 selects, from the correspondence table, which stores logical addresses correlated with secure hash values, the secure hash value of the block to be read. The storage apparatus 101 then uses the secure hash value of the block to be read and identifies the physical address by referring to the index to search for the physical address from the secure hash value. The storage apparatus 101 reads in the contents of the block to be read, from the identified physical address.

In the reading process and the writing process described above, the index for searching for the physical address from the secure hash value becomes enormous. Because of the use of the secure hash value, records within the index have little locality and for example, even if some records are stored in the memory, shuffling of the records is caused to happen frequently and processing performance drops. Accordingly, use of a Bloom filter can reduce the amount of data of the index. When the bit of the Bloom filter is ON, it indicates a positive or a false positive and when the bit is OFF, it indicates a negative. Configuration may be such that a bit value of 1 will be treated as ON and a bit value of 0 as OFF and conversely, configuration may be such that a bit value of 0 will be treated as ON and a bit value of 1 as OFF. In this embodiment, a bit value of 1 is treated as ON and a bit value of 0 as OFF.

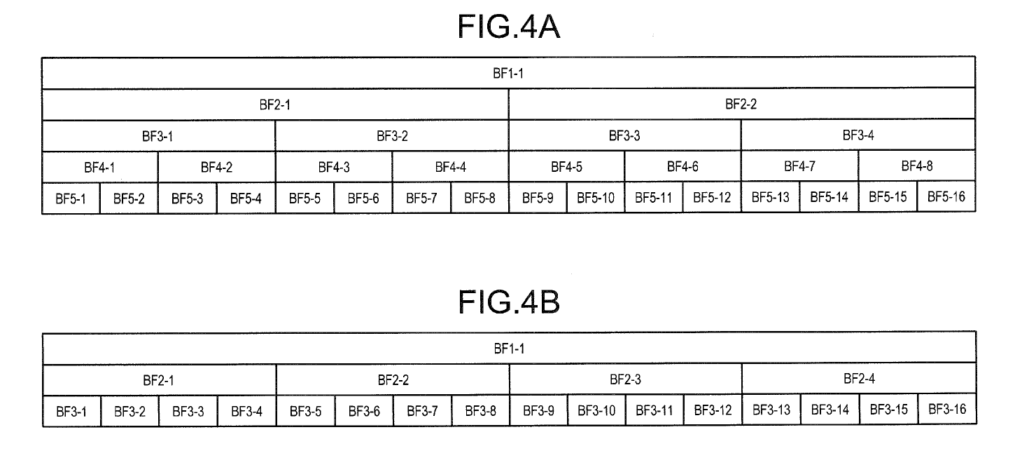

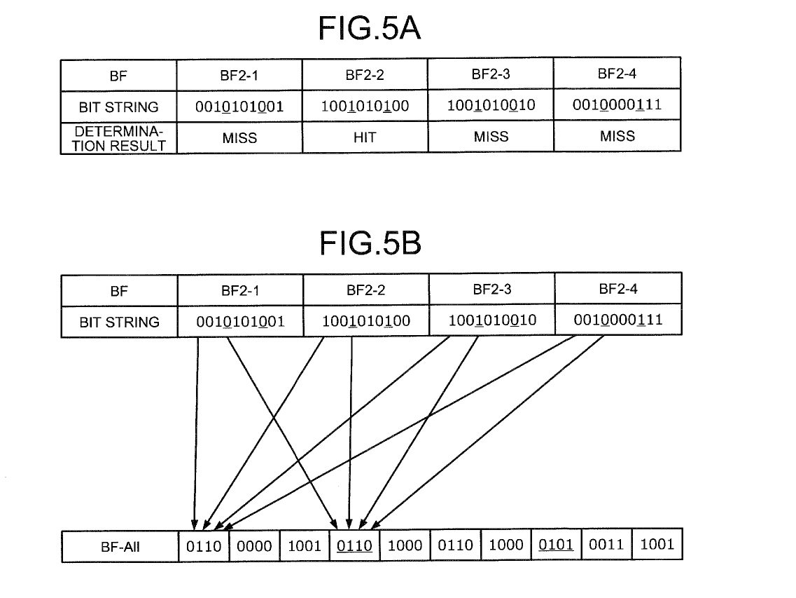

There is a technology of narrowing down the range of a search by preparing plural Bloom filters and determining in which Bloom filter data is hit. The technology of using plural Bloom filters will be described later in FIGS. 4 and 5. Thus, while the use of the Bloom filter can suppress the amount of data of the index, the Bloom filters that correspond to all indexes must be arranged in the memory and the Bloom filters must be tested, resulting in a large amount of processing.

Therefore, the storage apparatus 101 prepares plural small Boom filters and stores in the memory, some of the Bloom filters in which data is predicted to be hit. This makes it possible to suppress the amount of processing required for the deduplication while performing the deduplication to a given extent. The storage capacity of the memory can also be reduced.

In FIG. 1, the storage apparatus 101 stores a Bloom filter 105 in which the secure hash value of a block stored in at least any one area selected from among plural areas 104-1 to 104-n into which the storage area of the volume 102 is divided. The Bloom filter 105 depicted in FIG. 1 indicates ON of some bits among the bit string as a darkened area.

To select the area predicted to be hit, it is preferable to follow the cache algorithm. For example, the storage apparatus 101 selects an area recently accessed or an area frequently accessed. It is highly likely that a Bloom filter in which the secure hash values of blocks written to each area are registered will include the secure hash value of a block divided from the same file. Therefore, a Bloom filter in which the secure hash values of the blocks written to the areas are registered has high locality. Because of the high locality, it is highly likely that the Bloom filter, in which the secure hash value of given data to be written has been hit, will yield a hit of the secure hash value of subsequent data to be written. The storage apparatus 101 may divide the storage area of the index that is for searching for the physical address from the secure hash value. In the example of FIG. 1, for simplification of description, description will be made using the example of simply storing the blocks in the divided areas.

The storage apparatus 101, upon acceptance of a block to be written 106, calculates a secure hash value 107 of the block to be written 106. In the example of FIG. 1, the bit corresponding to the secure hash value 107 is indicated as a darkened area. The storage apparatus 101 judges whether a data characteristic value of the same contents as the secure hash value 107 is not registered in the Bloom filter 105. Hereinafter, “the data characteristic value of the same contents as a given secure hash value is registered in the Bloom filter” is sometimes described simply as “a given secure hash value is registered in the Bloom filter”. In the example of FIG. 1, since the bit corresponding to the secure hash value 107 is not darkened in the Bloom filter 105, the storage apparatus 101 judges that the data characteristic value of the same contents as the secure hash value 107 is not registered in the Bloom filter 105.

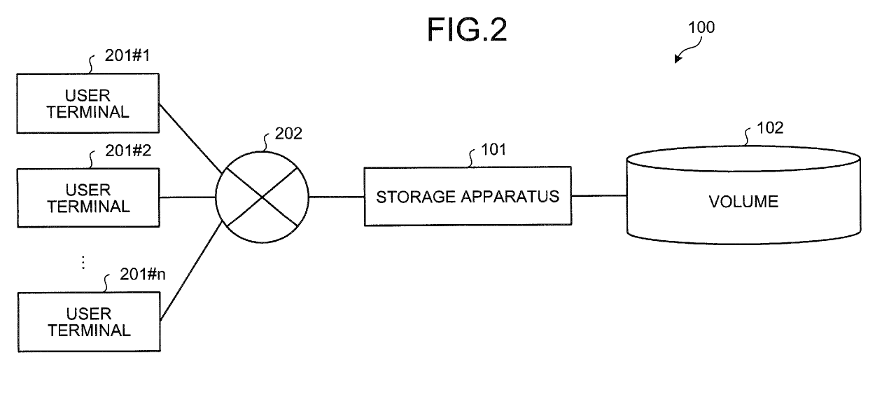

If it is judged that the data characteristic value of the same contents as the secure hash value 107 is not registered in the Bloom filter 105, the storage apparatus 101 writes the block to be written 106 into the area 104-2. Thus, by allowing a given amount of duplicate data, the storage apparatus 101 can suppress the amount of processing required for the deduplication while performing a given degree of deduplication. Details will be described of the storage apparatus 101 with reference to FIGS. 2 to 18.

FIG. 2 is an explanatory diagram of a connection example of the storage system. The storage system 100 includes the storage apparatus 101, the volume 102, and user terminals 201#1 to 201#n. The storage apparatus 101 and the user terminals 201#1 to 201#n are connected by a network 202 such as the Internet, a local area network (LAN), and a wide area network (WAN).

The user terminals 201#1 to 201#n are clients that use the storage system 100. For example, the user terminals 201#1 to 201#n are typically personal computers (PCs) and use application software such as a Web browser to connect to the storage apparatus 101 and use the storage system 100. The application software is hereinafter referred to as “application”.

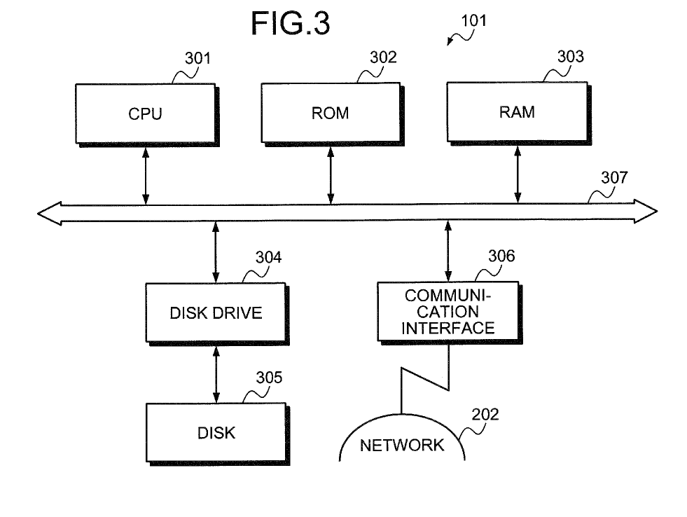

FIG. 3 is a block diagram of a hardware configuration of the storage apparatus. As depicted in FIG. 3, the storage apparatus 101 includes a central processing unit (CPU) 301, read-only memory (ROM) 302, random access memory (RAM) 303, a disk drive 304, a disk 305, and a communication interface 306, respectively connected by a bus 307.

The CPU 301 is a computation processing apparatus that governs overall control of the storage apparatus 101. The ROM 302 is non-volatile memory that stores programs such a boot program. The RAM 303 is volatile memory used as a work area of the CPU 301.

The disk drive 304, under the control of the CPU 301, controls the reading and writing of data with respect to the disk 305. For example, a magnetic disk drive, a solid state drive, and the like may be adopted as the disk drive 304. The disk 305 is non-volatile memory that stores data written thereto under the control of the disk drive 304. For example, when the disk drive 304 is a magnetic disk drive, the disk 305 may be a magnetic disk. Further, when the disk drive 304 is a solid state drive, the disk 305 may be semiconductor memory.

The communication interface 306 is a control apparatus that administers an internal interface with the network 202 and controls the input and output of data with respect to other apparatuses. For example, a modem or a LAN adaptor may be employed as the communication apparatus 306. Further, the storage apparatus 101 may have an optical disk drive, an optical disk, a keyboard, and a mouse.

With reference to FIGS. 4 and 5A, a multi-tier Bloom filter will be described that uses a Bloom filter as an index that indicates the storage location of the data. Hereinafter, the Bloom filter is sometimes referred to as BF and the multi-tiered Bloom filter is sometimes referred to as a multi-Bloom filter (MBF).

FIGS. 4A and 4B are explanatory diagrams of one example of the contents of the MBF. FIG. 4A depicts a 2-division, 5-tier MBF. For example, a first-tier Bloom filter is a BF1-1. A second-tier Bloom filter is a BF2-1 and a BF2-2 as subordinates of the BF1-1. A third-tier Bloom filter is a BF3-1 and a BF3-2 as subordinates of the BF2-1 and a BF-3-3 and a BF3-4 as subordinates of the BF2-2. A fourth-tier Bloom filter is a BF4-1 and a BF4-2 as subordinates of the BF3-1, a BF4-3 and a BF4-4 as subordinates of the BF3-2, a BF4-5 and a BF4-6 as subordinates of the BF3-3, and a BF4-7 and a BF4-8 as subordinates of the BF3-4.

A fifth-tier Bloom filter includes a BF5-1 and a BF5-2 as subordinates of the BF4-1, a BF5-3 and a BF5-4 as subordinates of the BF4-2, a BF5-5 and a BF5-6 as subordinates of the BF4-3, and a BF5-7 and a BF5-8 as subordinates of the BF4-4. The fifth-tier Bloom filter further includes a BF5-9 and a BF5-10 as subordinates of the BF4-5 and a BF5-11 and a BF5-12 as subordinates of the BF4-6. The fifth-tier Bloom filter further includes a BF5-13 and a BF5-14 as subordinates of the BF4-7 and a BF5-15 and a BF5-16 as subordinates of the BF4-8.

If the hash value of data searched-for is not hit in a test of the first-tier Bloom filter BF1-1, then the storage apparatus 101 judges that the data searched-for is not included.

If the data searched-for is hit in the test of the Bloom filter BF1-1, the storage apparatus 101 judges if the data searched-for is hit in the second-tier Bloom filter BF2-1. If the BF2-1 does not yield a hit, the storage apparatus 101 searches to see if the data searched-for is included in the Bloom filter BF2-2. Thus, if a Bloom filter yields a hit, the storage apparatus 101 performs the test of subordinate Bloom filters thereof and narrows down the range of search, thereby reaching the target data.

The Bloom filter, which has the false positive, can cause an erroneous detection. In the case of erroneous detection, the storage apparatus 101 is only required to go back to the superior Bloom filter and test the untested Bloom filter. Suppose, for example, that the storage apparatus 101 gets a hit in the test of the BF4-1 but does not get a hit in the test of the BF5-1 or the BF5-2. In this case, the hit in the test of the BF4-1 is the false positive and the storage apparatus 101 goes back to the superior Bloom filter and performs the test of the BF4-2, which is next.

The storage apparatus 101 can reduce the number of tiers by controlling the number of divisions. FIG. 4B depicts a 4-division, 3-tier MBF. For example, the first-tier Bloom filter is the BF1-1. The second-tier Bloom filter is the BF2-1, the BF2-2, a BF2-3, and a BF2-4 as subordinates of the BF1-1. The third-tier Bloom filter includes the BF3-1, the BF3-2, the BF3-3, and the BF3-4 as subordinates of the BF2-1 and a BF3-5, a BF3-6, a BF3-7, and a BF3-8 as subordinates of the BF2-2. The third-tier Bloom filter further includes a BF3-9, a BF3-10, a BF3-11, and a BF3-12 as subordinates of the BF2-3 and a BF3-13, a BF3-14, a BF3-15, and a BF3-16 as subordinate of the BF2-4.

FIGS. 5A and 5B are explanatory diagrams of one example of storing bits of the MBF after transposition. To speed up the MBF search depicted in FIGS. 4A and 4B, FIGS. 5A and 5B describe a method of reducing the number of time memory is accessed at the time of searching, by changing the memory arrangement and giving locality to the contents.

FIG. 5A depicts the BF2-1, the BF2-2, the BF2-3, and the BF2-4 depicted in FIG. 4B as four Bloom filters before the transposition. It is assumed that the bit string of the BF2-1 is “0010101001”, that the bit string of the BF2-2 is “1001010100”, that the bit string of the BF2-3 is “1001010010”, and that the bit string of the BF2-4 is “0010000111”. The storage apparatus 101 judges whether the data to be searched-for is possibly registered, or is not registered, based on the third and the seventh bits from the head. In the description of FIGS. 5A and 5B, the head is counted as the 0th bit. As a result of the judgment, since the BF2-2 having “1” at the third and the seventh bits is hit, the storage apparatus 101 proceeds to the judgment of the subordinate Bloom filters of the BF2-2.

FIG. 5B is an example of the transposition of the BF2-1 to BF2-4. A transposed BF-All has the bit string of the 0th bit of the BF2-1, . . . , the 0th bit of the BF2-4, . . . , the 9th bit of the BF2-1, . . . , the 9th bit of the BF2-4. With respect to such a bit string of the BF-All, the storage apparatus 101 performs an AND operation of the third 4 bits “0110” and the seventh 4 bits “0101” of the BF-All. Since the first bit becomes 1 as seen from “0100” as a result of the AND operation, the storage apparatus 101 can judge that the BF2-2 is hit.

In the example of FIG. 5A, two accesses occur for one Bloom filter and a total of eight accesses occur. By contrast, in the example of FIG. 5B, only two accesses are performed. In an application of the example of FIG. 5B, for example, in a case of dividing into 64 Bloom filters, the storage apparatus 101 performs the AND operation of 64 bits and judges that a Bloom filter is hit that corresponds to “1”-part out of the bit string as a result of the operation. According to the method of FIG. 5B, the storage apparatus 101 is only required to perform the AND operation of 4 [kB] memory block and can judge the “1”-part of the bit string as a result of the AND operation within the time in the order of no more than several microseconds.

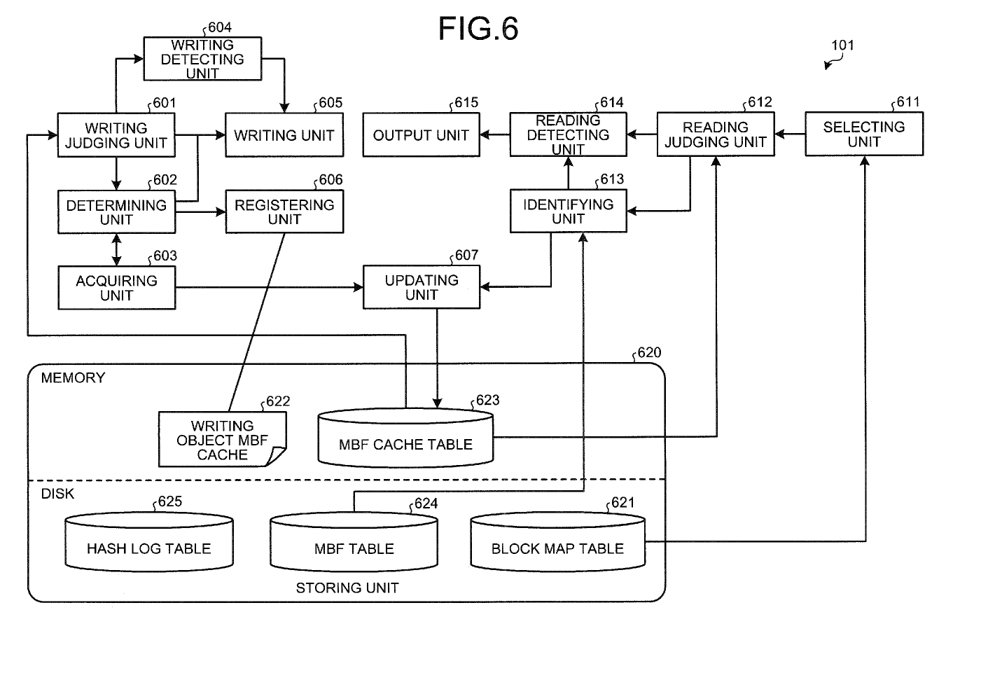

Functions of the storage apparatus 101 will be described. FIG. 6 is a block diagram of an example of functions of the storage apparatus. The storage apparatus 101 includes a writing judging unit 601, a determining unit 602, an acquiring unit 603, a writing detecting unit 604, a writing unit 605, a registering unit 606, an updating unit 607, a selecting unit 611, a reading judging unit 612, an identifying unit 613, a reading detecting unit 614, and an output unit 615. Functions of the writing judging unit 601 to the output unit 615, serving as a control unit, are implemented by executing on the CPU 301, a program that is stored in a storage device. The storage device is, for example, the ROM 301, the RAM 303, the disk 305, etc., depicted in FIG. 3.

The storage apparatus 101 can access a storing unit 620. The storing unit 620 is storage devices such as the RAM 303 and the disk 305. The storing unit 620 includes a block map table 621, a writing object MBF cache 622, an MBF cache table 623, an MBF table 624, and a hash log table 625. The writing object MBF cache 622 and the MBF cache table 623 reside in the memory serving as a main storage unit such as the RAM 303 and a register, a cache memory, etc. of the CPU 301. The block map table 621, the MBF table 624, and the hash log table 625 reside in a disk serving as an auxiliary storage unit such as the disk 305.

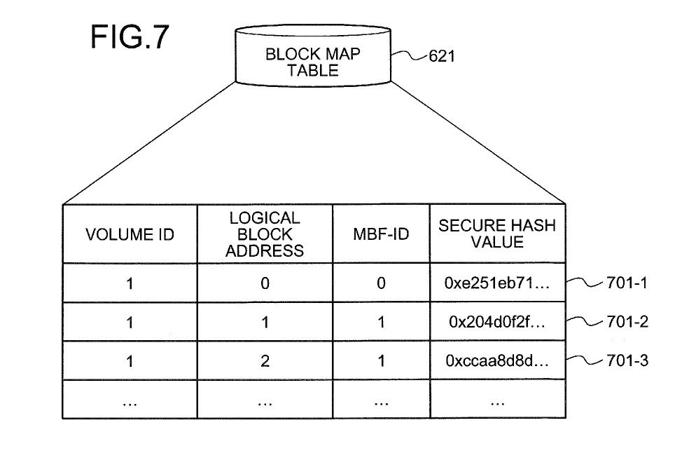

The block map table 621 correlates and stores the secure hash value of each block to be written and the logical address of each data to be written, corresponding to each data to be written among a group of data to be written. Details of the block map table 621 will be described in FIG. 7.

The writing object MBF cache 622 and the MBF cache table 623 store the Bloom filter that has the secure hash value of the block stored in at least any one area selected from among areas into which the storage area of the volume 102 is divided. The MBF cache table 623 may include the writing object MBF cache 622 within itself. The MBF cache table 623 may store the Bloom filter that has the secure hash value of the block stored in at least any one area selected from among areas into which the storage area of the hash log table 625 is divided. In this embodiment, description will be made using the example of dividing the storage area of the hash log table 625.

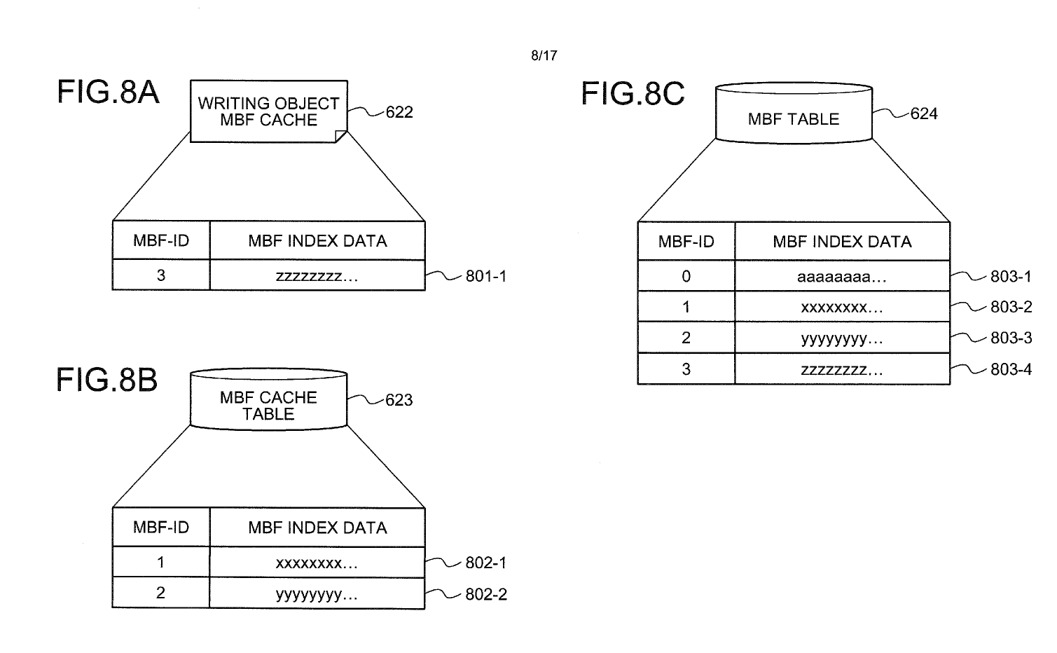

The MBF table 624 stores the Bloom filter that has for each area, the secure hash value of the block stored in the area. Details of the writing object MBF cache 622 to the MBF table 624 will be described later in FIG. 8C.

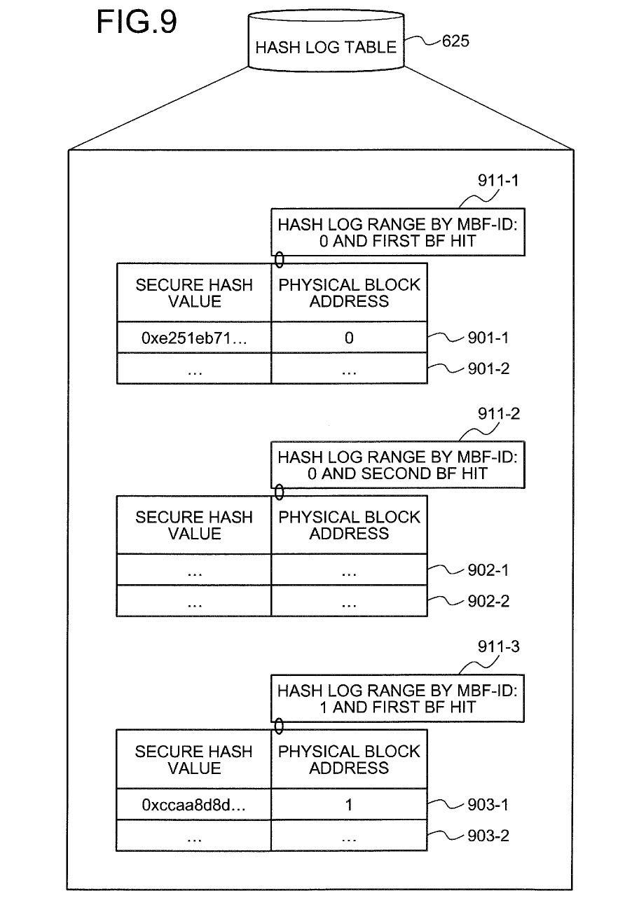

The hash log table 625 corresponds to the index that is for searching for the physical address from the secure hash value described in FIG. 1. Details of the hash log table 625 will be described later in FIG. 9.

The writing judging unit 601 judges whether a secure hash value of the same contents as that of a first secure hash value of the data to be written to the storage area of the hash log table 625 is not registered in the Bloom filter of the MBF cache table 623. The Bloom filter in the MBF cache table 623 may be one Bloom filter or may be plural Bloom filters. Results of the judgment are stored in the register and the cache memory of the CPU 301, the RAM 303, etc.

If it is judged by the writing judging unit 601 that a secure hash value of the same contents is not registered, the determining unit 602 determines whether to register the first secure hash value in the Bloom filter of the writing object MBF cache 622, based on the following condition. The “following condition” indicates the number of secure hash values already registered in the writing object MBF cache 622.

If another Bloom filter is acquired by the acquiring unit 603, the determining unit may determine whether to register the first secure hash value in the other Bloom filter, based on the number of the secure hash values already registered in the other Bloom filter. Results of the determination are stored in the register and the cache memory of the CPU 301, the RAM 303, etc.

If the determining unit 602 determines not to register the first secure hash value in the Bloom filter, the acquiring unit 603 acquires from the storing unit 620, another Bloom filter different from the Bloom filter of the MBF cache table 623. The other Bloom filter may be a Bloom filter newly prepared in the storing unit 620 or may be a Bloom filter that has not reached the registration upper limit number among the Bloom filters of the MBF table 624. Results of the acquisition are stored in the register and the cache memory of the CPU 301, the RAM 303, etc.

If it is judged by the writing judging unit 601 that a secure hash value of the same contents is registered, the writing detecting unit 604 detects the data having the secure hash value of the same contents from at least any one area. Results of the detection are stored in the register and the cache memory of the CPU 301, the RAM 303, etc.

If it is judged by the writing judging unit 601 that a secure hash value of the same contents is not registered, the writing unit 605 writes the data to be written to the storage area of the volume 102. If, because of the division of the storage area of the hash log table 625, it is judged by the writing judging unit 601 that a secure hash value of the same contents is not registered, the writing unit 605 writes to the hash log table 625, the physical address at which the data that is to be written is stored.

If the determining unit 602 determines to register the first secure hash value in the Bloom filter, the writing unit 605 may write to at least any one area, the data that is to be written.

If the determining unit 602 determines to register the first secure hash value in another Bloom filter, the writing unit 605 may write to an area that stores data having a secure hash value registered in the other Bloom filter, the data that is to be written. If data having a secure hash value of the same contents is detected by the writing detecting unit 604, the writing unit 605 need not write to the storage area of the volume 102, the data that is to be written. If data having a secure hash value of the same contents is not detected by the writing detecting unit 604, the writing unit 605 may write to the storage area of the volume 102, the data that is to be written.

If the determining unit 602 determines to register the first secure hash value in the Bloom filter, the registering unit 606 registers the first secure hash value in the Bloom filter.

The updating unit 607 updates the contents of the writing object MBF cache 622, based on the other Bloom filter acquired by the acquiring unit 603. For example, the updating unit 607 saves the data of the writing object MBF cache 622 to the MBF cache table 623 and overwrites the writing object MBF cache 622 with the other Bloom filter. At the time of saving the writing object MBF cache 622 to the MBF cache table 623, if there is an empty area in the MBF cache table 623, the updating unit 607 writes the data of the writing object MBF cache 622 in the empty area. If there is no empty area in the MBF cache table 623, the updating unit 607 overwrites an old record with the other Bloom filter.

The updating unit 607 may update the contents of the writing object MBF cache 622, based on the Bloom filter that has the data having a secure hash value of the same contents as that of a second secure hash value identified by the identifying unit 613.

The selecting unit 611 selects from the block map table 621, the second secure hash value correlated with the logical address of the data that is to be read. Results of the selection are stored in the register and the cache memory of the CPU 301, the RAM 303, etc.

The reading judging unit 612 judges whether a secure hash value of the same contents as that of the second secure hash value selected by the selecting unit 611 is not registered in the Bloom filter of the MBF cache table 623. Results of the judgment are stored in the register and the cache memory of the CPU 301, the RAM 303, etc.

In the following case, the identifying unit 613 identifies the Bloom filter that has data having a secure hash value of the same contents as that of the second secure hash value, from among the Bloom filters of the MBF table 624. The “following case” indicates a case in which it is judged by the reading judging unit 612 that a secure hash value of the same contents as that of the second secure hash value is not registered. Results of the identification are stored in the register and the cache memory of the CPU 301, the RAM 303, etc.

In the following case, the reading detecting unit 614 detects from at least any one area, data having a secure hash value of the same contents as that of the second secure hash value. The “following case” indicates a case in which it is judged by the reading judging unit 612 that a secure hash value of the same contents as that of the second secure hash value is registered.

The reading detecting unit 614 may detect a data having a secure hash value of the same contents as that of the second secure hash value, from the area in which the data is stored that has the secure hash value registered in the Bloom filter identified by the identifying unit 613. Results of the detection are stored in the register and the cache memory of the CPU 301, the RAM 303, etc.

If data having a secure hash value of the same contents as that of the second secure hash value is detected by the reading detecting unit 614, the output unit 615 outputs the data having the secure hash value of the same contents as that of the second secure hash value. Output may be to a storage area of the RAM 303, the disk 305, etc., or may be to the application of the user terminal 201 that made a read request.

FIG. 7 is an explanatory diagram of one example of the contents of the block map table. The block map table 621 stores for each block, the storage location of the block in the volume, the ID of the Bloom filter in which the block is registered, and the secure hash value of the block. The block map table 621 depicted in FIG. 7 has records 701-1 to 701-3. The block map table 621 includes four fields including a volume ID, a logic block address, an MBF-ID, and the secure hash value. The volume ID field stores an identification number of the volume of an object block. The volume is used by an application that uses a service of the storage system. The logical block address field stores the logical address of the object block. The MBF-ID filed stores the identification number of the Bloom filter registering the block. The secure hash value field stores the secure hash value of the object block.

For example, for the block indicated by record 701-1, the volume ID of the volume storing the block is 1, the logical block address is 0, the MBF-ID of the object block is 0, and the secure hash value of the object block is 0xe251e71 . . . .

FIGS. 8A, 8B, and 8C are explanatory diagrams of one example of the contents of the writing object MBF cache, the MBF cache table, and the MBF table. The writing object MBF cache 622, the MBF cache table 623, and the MBF table 624 have same fields of the MBF-ID and the MBF index data. The writing object MBF cache 622 depicted in FIG. 8A has a record 801-1. The MBF cache table 623 depicted in FIG. 8B has records 802-1 and 802-2. The MBF table 624 depicted in FIG. 8C has records 803-1 to 803-4. Record 801-1 and record 803-4 are of the same contents. Record 802-1 and record 803-2 are of the same contents. Likewise, record 802-2 and record 803-3 are of the same contents.

The MBF-ID field stores the identification number of the Bloom filter. The MBF index data field stores a bit string as the Bloom filter. One MBF index data field may store plural Bloom filters. For example, in FIG. 4B, one MBF index data field may store BF2-1 and BF3-1 to BF3-4.

For example, record 801-1 indicates that the MBF-ID is 3 and that the bit string as the Bloom filter is “zzzzzzzz . . . ”.

FIG. 9 is an explanatory diagram of one example of contents of the hash log table. The hash log table 625 stores for each block, the secure hash value of the block and the physical block address at which the block is stored. The hash log table 625 depicted in FIG. 9 stores records 901-1 to 903-2. The hash log table 625 has two fields including the secure hash value and the physical block address. The secure hash value field stores the secure hash value of the object block. The physical block address field stores the physical block address at which the object block is stored.

The hash log table 625 comes to have an enormous number of records and therefore, to narrow down the range of a search, the contents of the hash log table 625 are divided, for each Bloom filter for which the MBF-ID is hit. The range of search narrowed down by the Bloom filters that yield a hit is hereinafter referred to as “hash log range”. In the example of FIG. 9, the block searched-for whose MBF-ID is 0 and that is hit in the first BF is included in hash log range 911-1. Hash log range 911-1 includes records 901-1 and 901-2. Likewise, the block searched-for whose MBF-ID is 0 and that is hit in the second BF is included in hash log range 911-2 and the block searched-for whose MBF-ID is 1 and that is hit in the first BF is included in hash log range 911-3.

For example, it is assumed that the BF2-1 and the BF3-1 to BF3-4 are stored in the MBF index data field of record 803-1 depicted in FIG. 8C. If the hash value of the block searched-for is hit in the BF3-1 of the MBF index data of record 803-1, the block searched-for is included in hash log range 911-1. Therefore, to obtain the block searched-for, the storage apparatus 101 is merely has to search the group of records included in hash log range 911-1.

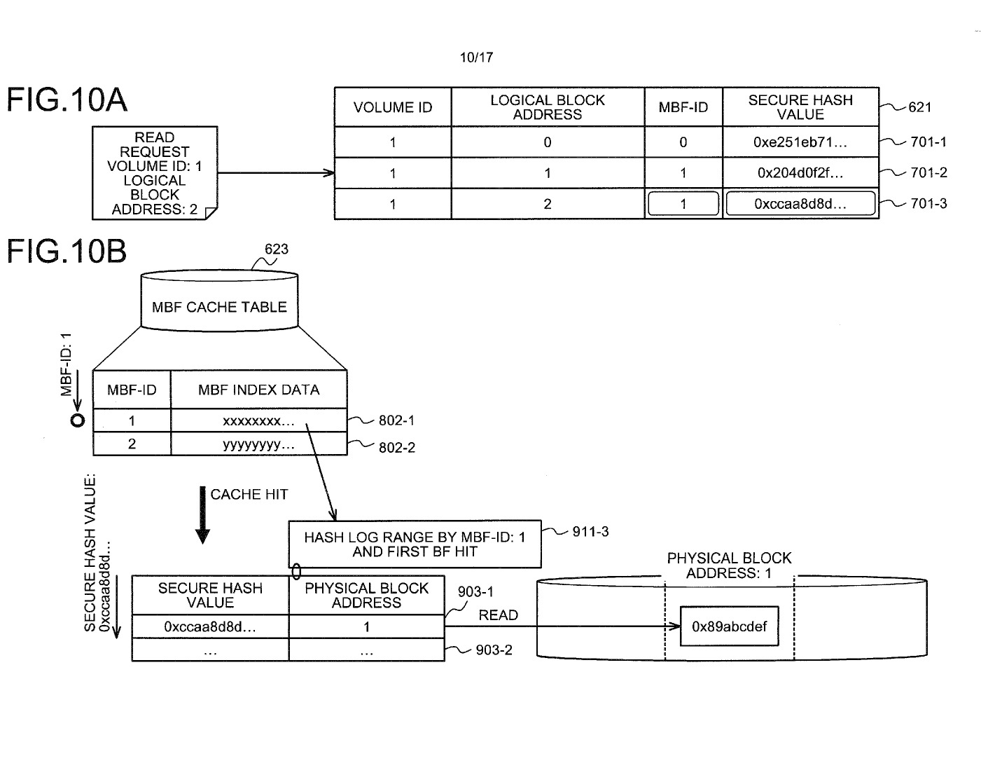

An operation of the reading process and the writing process of the storage apparatus 101 will be described with reference to FIGS. 10A to 13, using the contents depicted in FIGS. 7 to 9. FIGS. 10A to 13 describe cases according to whether the hash value of the block to be read or the block to be written is hit in the MBF index data of the MBF cache table 623. The MBF index data, which is to be searched, may include the writing object MBF cache 622 in addition to the MBF cache table 623. In the description of FIGS. 10A to 13, for simplification of description, the MBF index data of the MBF cache table 623 is searched.

FIGS. 10A and 10B are explanatory diagrams of an operation example of the reading process. FIGS. 10A and 10B depict an example when the hash value of the block to be read is hit in the MBF index data of the MBF cache table 623.

The storage apparatus 101 accepts from the application, a request to read the block having the volume ID of “1” and the logical block address of “2”. The storage apparatus 101 then detects the record having the volume ID of “1” and the logical block address of “2” in the block map table 621. In the example of FIGS. 10A and 10B, since record 701-3 is applicable, the storage apparatus 101 acquires the value “1” of the MBF-ID field and the value “0xccaa8d8d . . . ” of the secure hash value field of record 701-3.

The storage apparatus 101 then searches for a record having “1” as the value of the MBF-ID field in the MBF cache table 623. In the example of FIGS. 10A and 10B, record 802-1 is hit. The storage apparatus 101 then judges which BF among the BFs stored in the MBF index data field of record-802-1 is hit by the acquired secure hash value “0xccaa8d8d . . . ”.

In the example of FIGS. 10A and 10B, it is assumed that the secure hash value “0xccaa8d8d . . . ” hits the first BF of the MBF index data of record 802-1. In the case of a hit, the storage apparatus 101 acquires hash log range 911-3 from the MBF index data of the detected record 802-1. The storage apparatus 101 then detects from among the group of records included in the hash log range 911-3 of the hash log table 625, record 903-1 storing the secure hash value “0xccaa8d8d . . . ” in the secure hash value field. The storage apparatus 101, using the value “1” of the physical block address field of the detected record 903-1, reads in “0x89abcdef” from the volume.

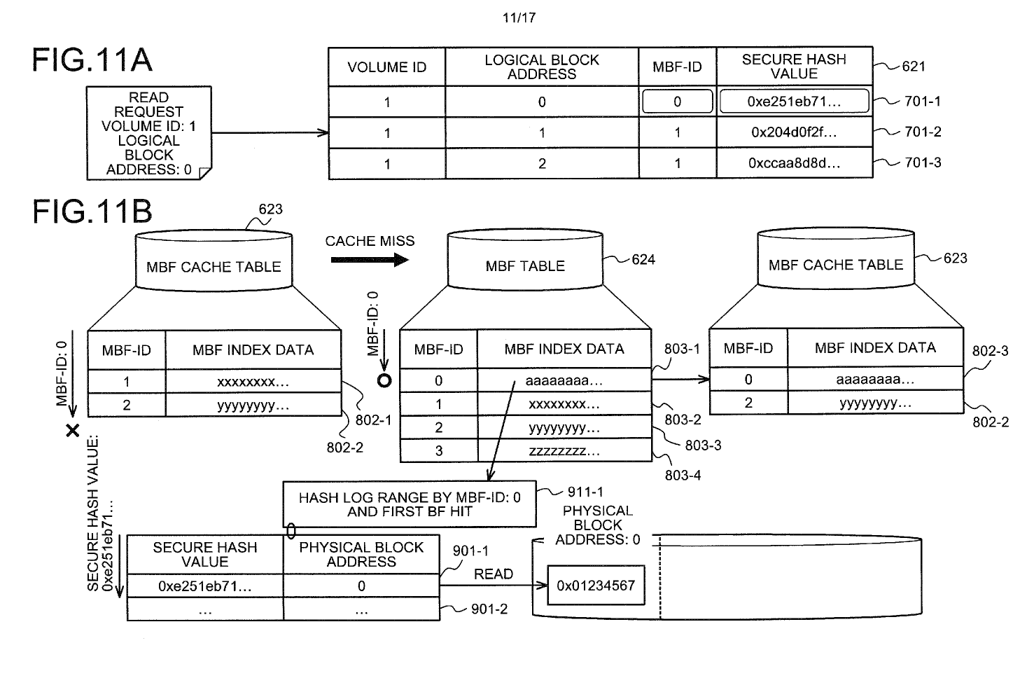

FIGS. 11A and 11B are explanatory diagrams of an operation example of the reading process. FIGS. 11A and 11B depicts the example when, at the time of the reading process, the hash value of the block to be read is not hit in the MBF index data of the MBF cache table 623.

The storage apparatus 101 accepts from the application, a request to read the block having the volume ID of “1” and the logical block address of “0”. The storage apparatus 101 then detects a record having the volume ID of “1” and the logical block address value of “0” in the block map table 621. In the example of FIGS. 11A and 11B, since record 701-1 is applicable, the storage apparatus 101 acquires the value “0 of the MBF-ID field and the value “0xe251eb71 . . . ” of the secure hash field of record 701-1.

The storage apparatus 101 then searches for a record having “0” as the value of the MBF-ID field from the MBF cache table 623. In the example of FIGS. 11A and 11B, the storage apparatus 101 detects no record having the MBF-ID of “0” and a cache miss occurs. In this case, the storage apparatus 101 searches for a record having the MBF-ID of “0” in the MBF table 624. In the example of FIGS. 11A and 11B, since record 803-1 is applicable, the storage apparatus 101 judges which BF among the BFs stored in the MBF index data field of record-803-1 is hit by the acquired secure hash value “0xe251eb71 . . . ”. The storage apparatus 101 updates the MBF cache table 623 with the contents of record 803-1. For example, the updated MBF cache table 623 has record 802-3, obtained by overwriting record 802-1 with the contents of record 803-1, and record 802-2.

As to which BF is hit, in the example of FIGS. 11A and 11B, it is assumed that the secure hash value “0xe251eb71 . . . ” hits the first BF in the MBF index data of record 803-1. In the case of a hit, the storage apparatus 101 acquires hash log range 911-1 in the MBF index data of the detected record 803-1. The storage apparatus 101 then detects from among the group of records included in hash log range 911-1 of the hash log table 625, record 901-1 that has the secure hash value “0xe251eb71 . . . ” stored in the secure hash value field. The storage apparatus 101, using the value “0” of the physical block address field of the detected record 901-1, reads in “0x01234567” from the volume.

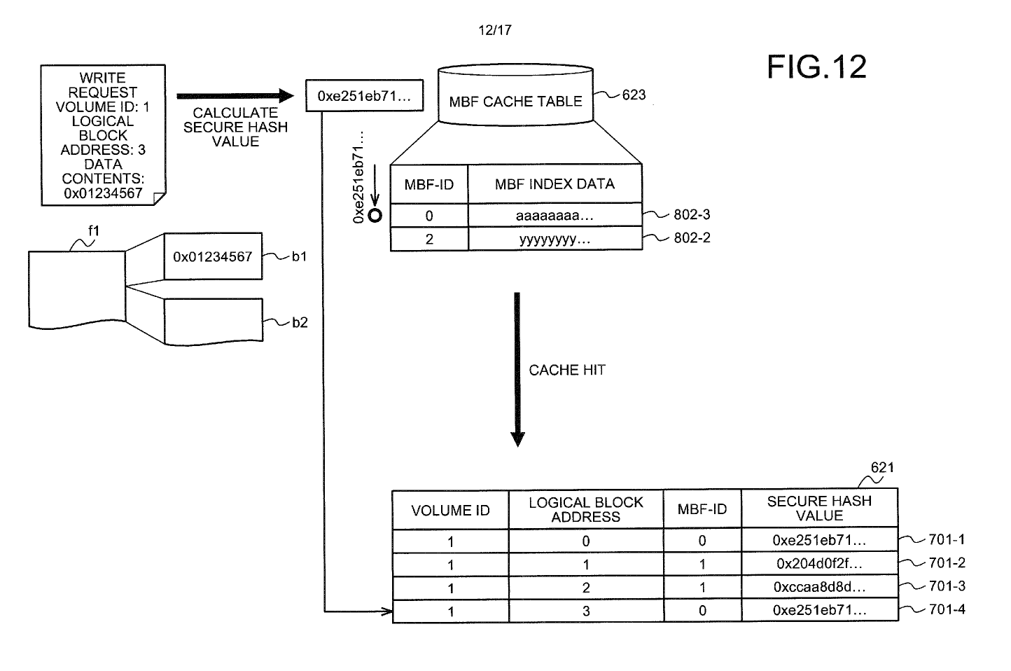

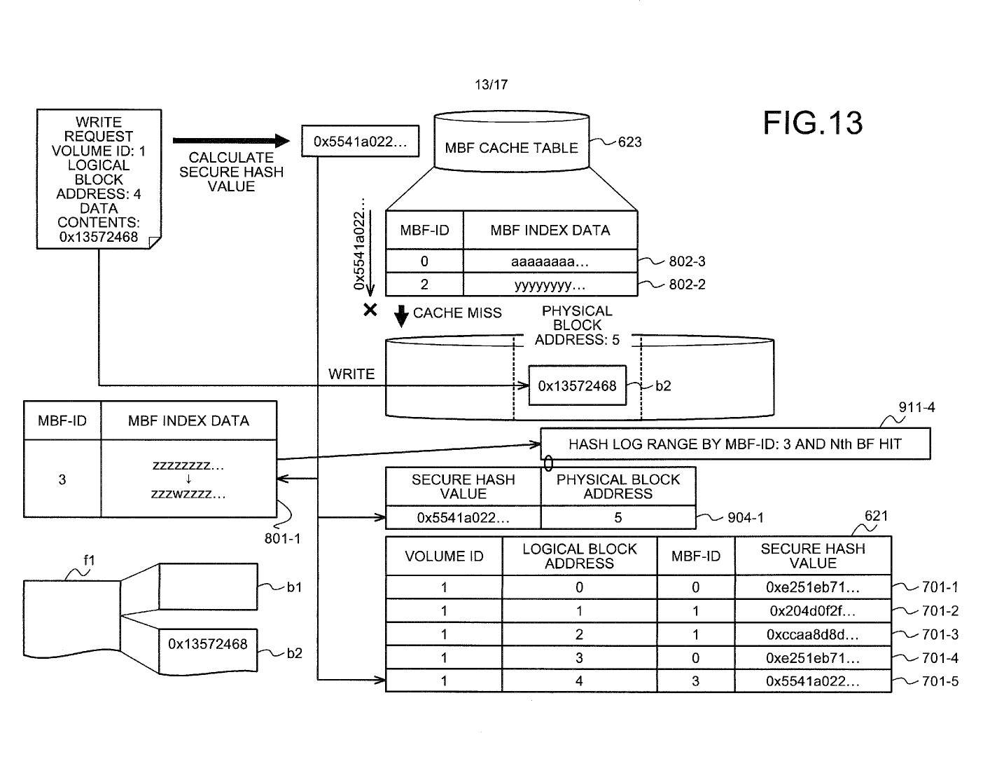

FIG. 12 is an explanatory diagram of an operation example of the writing process. FIG. 12 depicts an example when, at the time of the writing process, the hash value of the block to be written is hit in the MBF index data of the MBF cache table 623. In FIGS. 12 and 13, it is assumed that file f1, the writing of which is requested by the application, is divided into block b1 and block b2. It is assumed that data contents of block b1 are “0x01234567”.

The storage apparatus 101 accepts a request to write block b1 having the volume ID of “1”, the logical block address of “3”, and the data contents of “0x01234567”. The storage apparatus 101 then calculates the secure hash value of “0x01234567”. In the example of FIG. 12, it is assumed that the calculated secure hash value is “0xe251eb71 . . . ”. The storage apparatus 101 judges whether the secure hash value of “0xe251eb71 . . . ” hits any of the BFs stored in the MBF index data field of the records of the MBF cache table 623.

In the example of FIG. 12, it is assumed that the secure hash value of “0xe251eb71 . . . ” hits the first BF in the MBF index data of record 802-3. In the case of a hit, because of the potential of the false positive, the storage apparatus 101 confirms whether there is a record having the secure hash value “0xe251eb71 . . . ”. If there is the record, the block of the same contents is already included and as the deduplication, the storage apparatus 101 does not write the block for writing has been requested.

For example, since the same processing as the reading process described in FIGS. 10A and 10B is performed, illustration thereof is omitted from FIG. 12. In the example of FIG. 12, the storage apparatus 101 acquires hash log range 911-1 from the MBF index data of the detected record 802-3. The storage apparatus 101 confirms that there is a record having the secure hash value “0xe251eb71 . . . ” among the group of records included in hash log range 911-1 of the hash log table 625. If there is no such record, the storage apparatus 101 merely performs the same processing as the processing in the case of no hit in the MBF index data of the MBF cache table 623 depicted in FIG. 13.

After confirming that there is the record having the secure hash value “0xe251eb71 . . . ”, the storage apparatus 101, using the contents of the write request, updates the block map table 621. For example, if there is the record having the volume ID field value of “1” and the logical block address of “3 in the block map table 621, the storage apparatus 101 updates the applicable record and if there is no such record, the storage apparatus 101 adds the record. If there is the applicable record, the storage apparatus 101 updates the MBF-ID field of the applicable record with the value “0” of the MBF-ID field of the detected record 802-3 as well as updating the secure hash value with “0xe251eb71 . . . ”. The example of FIG. 12 is a case of there being no record and the storage apparatus 101 adding record 701-4.

FIG. 13 is an explanatory diagram of an operation example of the writing process. FIG. 13 depicts the example when, at the time of the writing process, the hash value of the block to be written is not hit in the MBF index data of the MBF cache table 623. It is assumed that the data contents of block b2 are “0x13572468”.

The storage apparatus 101 accepts a request to write block b2 having the volume ID of “1”, the logical block address of “4”, and the data contents of “0x13572468”. The storage apparatus 101 then calculates the secure hash value of “0x13572468”. In the example of FIG. 13, it is assumed that the calculated secure hash value is “0x5541a022 . . . ”. The storage apparatus 101 judges whether the secure hash value of “0x5541a022 . . . ” hits any of the BFs stored in the MBF index data field of the records of the MBF cache table 623.

In the example of FIG. 13, it is assumed that the secure hash value of “0x5541a022 . . . ” does not hit any record of the MBF cache table 623, resulting in a cache miss. In this case, the storage apparatus 101 writes the data contents “0x13572468” of block b2 to the area indicated by the physical address “5” of the volume. Further, the storage apparatus 101 registers the secure hash value “0x5541a022 . . . ” in the BF stored in the MBF index data field of record 801-1 of the MBF cache. In the example of FIG. 13, the registration of the secure hash value “0x5541a022 . . . ” is indicated by the change of the BF stored in the MBF index data field of record 801-1 from “zzzzzzzz . . . ” to “zzzwzzzz . . . ”.

The storage apparatus 101 acquires the value “3” of the MBF-ID field of record 801-1 and hash log range 911-4 specified by the BF in which the registration is made. The storage apparatus 101 adds record 904-1 having the value “0x5541a022 . . . ” of the secure hash value field and the value “5” of the physical block address field, as a record to be included in hash log range 911-4. The storage apparatus 101, using the contents of the write request, updates the block map table 621. In the example of FIG. 13, the storage apparatus 101 adds record 701-5.

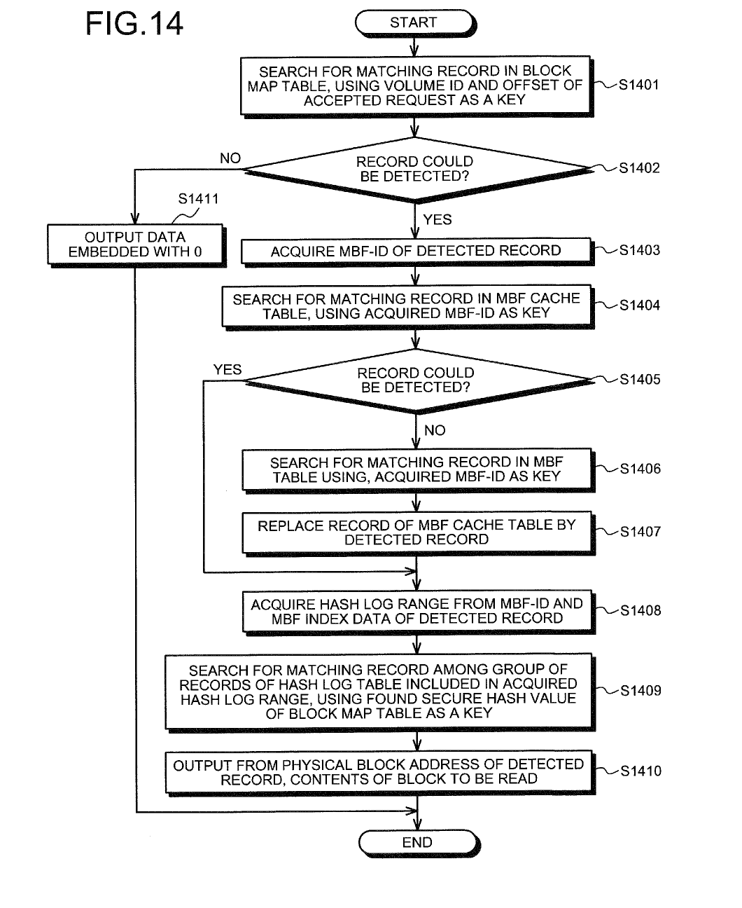

A flowchart of the operation of the reading process and the writing process described using FIGS. 10 to 13, will be described with reference to FIGS. 14 to 16.

FIG. 14 is a flowchart of one example of a procedure of the reading process. The reading process is processing to be performed at the time of acceptance of a request from the application and requesting the reading of a block. The storage apparatus 101, using the volume ID and the offset of the accepted request as a key to read, searches for a matching record in the block map table 621 (step S1401). The storage apparatus 101 judges whether a record could be detected (step S1402).

If a record could be detected (step S1402: YES), then the storage apparatus 101 acquires the MBF-ID of the detected record (step S1403). The storage apparatus 101, using the acquired MBF-ID as a key, searches for a matching record from the MBF cache table 623 (step S1404). The storage apparatus 101 judges if a record could be detected (step S1405). If a record could not be detected (step S1405: NO), the storage apparatus 101, using the acquired MBF-ID as a key, searches for a matching record in the MBF table 624 (step S1406). The storage apparatus 101 replaces the record of the MBF cache table 623 by the detected record (step S1407).

After the completion of execution of step S1407 or if a record could be detected (step S1405: YES), the storage apparatus 101 acquires the hash log range from the MBF-ID and the MBF index data of the detected record (step S1408). The storage apparatus 101, using the secure hash value found in the block map table 621 as a key, searches for a matching record among the group of records of the hash log table 625 included in the acquired hash log range (step S1409). The storage apparatus 101 outputs the contents of the block to be read from the physical block address of the detected record (step S1410).

If a record could not be detected (step S1402: NO), the storage apparatus 101, judging that the requested block is not a block written by the application, outputs data embedded with 0 (step S1411). After the completion of execution of step S1410 or step S1411, the storage apparatus 101 ends the reading process. With the execution of the reading process, the storage apparatus 101, by using the BF to the storage to which the deduplication technology was applied, can perform high-speed judgment of the storage location of the block and therefore, can perform the reading of the block contents at high speed.

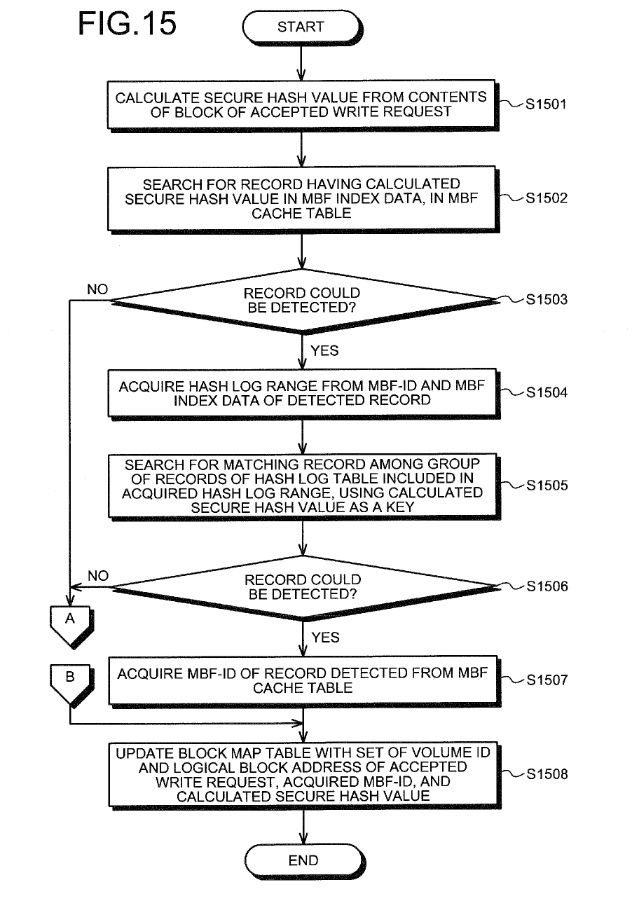

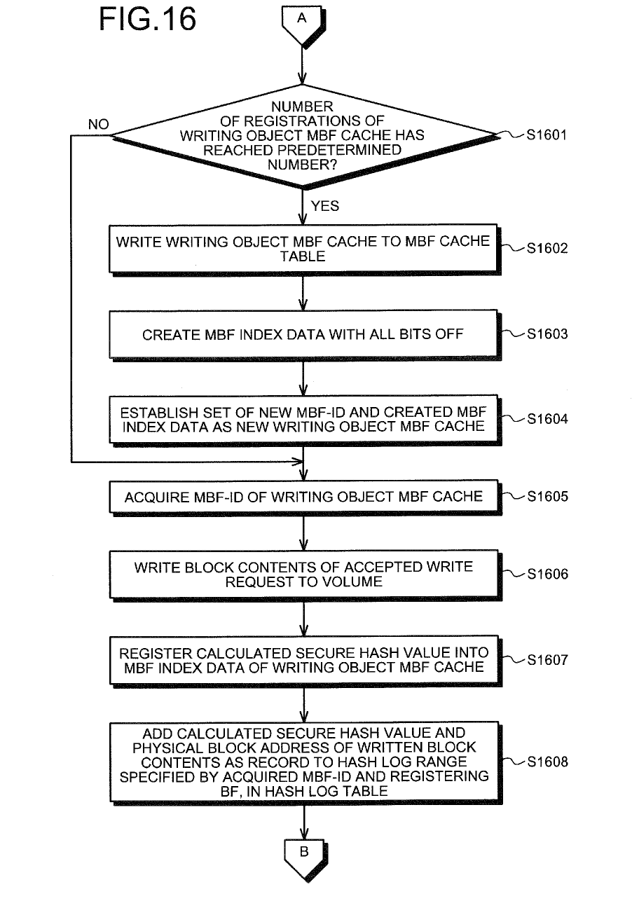

FIG. 15 is a flowchart of an example of a procedure of the writing process. FIG. 16 is another flowchart of the example of the procedure of the writing process. The writing process is processing to be performed at the time of acceptance of a request from the application and requesting the writing of a block.

The storage apparatus 101 calculates the secure hash value from the contents of the block of the accepted write request (step S1501). The storage apparatus 101 searches for a record having the calculated secure hash value in the MBF index data, in the MBF cache table 623 (step S1502). The storage apparatus 101 judges if a record could be detected (step S1503). If a record could not be detected (step S1503: NO), the storage apparatus 101 proceeds to the operation at step S1601 depicted in FIG. 16.

If a record could be detected (step S1503: YES), the storage apparatus 101 acquires the hash log range from the MBF-ID and the MBF index data of the detected record (step S1504). The storage apparatus 101, using the calculated secure hash value as a key, searches for a matching record among the group of records of the hash log table 625 included in the acquired hash log range (step S1505). The storage apparatus 101 judges if a record could be detected (step S1506). If a record could not be detected (step S1506: NO), storage apparatus 101 goes to the operation at step S1601 depicted in FIG. 16.

If the record could be detected (step S1506: YES), then the storage apparatus 101 acquires the MBF-ID of the record detected from the MBF cache table 623 (step S1507). After the completion of the operation at step S1507, the storage apparatus 101 updates the block map table 621 with a set of the volume ID and the logical block address of the accepted write request, the acquired MBF-ID, and the calculated secure hash value (step S1508). After the completion of the operation at step S1608 depicted in FIG. 16 as well, the storage apparatus 101 executes the operation at step S1508. After the completion of execution of step S1508, the storage apparatus 101 ends the writing process.

In the case of step S1503: NO or step S1506: NO, the storage apparatus 101 judges if the number of registrations of the writing object MBF cache has reached a predetermined number (step S1601). If the number of registrations of the MBF cache has reached the predetermined number (step S1601: YES), the storage apparatus 101 writes the writing object MBF cache 622 to the MBF cache table 623 (step S1602). With respect the operation at step S1602, old records present in the MBF cache table 623 are directly discarded since the same contents are in the MBF table 624. The storage apparatus 101 creates the MBF index data with all bits OFF (step S1603). The storage apparatus 101 establishes a set of a new MBF-ID and the created MBF index data as a new writing object MBF cache 622 (step S1604). In the operation at step S1603 and step S1604, if there is another BF that has not reached the upper limit number, the storage apparatus 101 may establish the BF as a new writing object MBF cache 622, without executing the operation at step S1603.

After the completion of the operation at step S1604 or if the number of registrations of the MBF cache has not reached the predetermined number (step S1601: NO), the storage apparatus 101 acquires the MBF-ID of the writing object MBF cache 622 (step S1605). The storage apparatus 101 then writes the block contents of the accepted write request to the volume (step S1606). The storage apparatus 101 registers the calculated secure hash value in the MBF index data of the writing object MBF cache 622 (step S1607). The storage apparatus 101 adds the calculated secure hash value and the physical block address of the written block contents as a record to the hash log range specified by the acquired MBF-ID and the registering BF, in the hash log table 625 (step S1608). After the completion of the operation at step S1608, the storage apparatus 101 proceeds to step S1508.

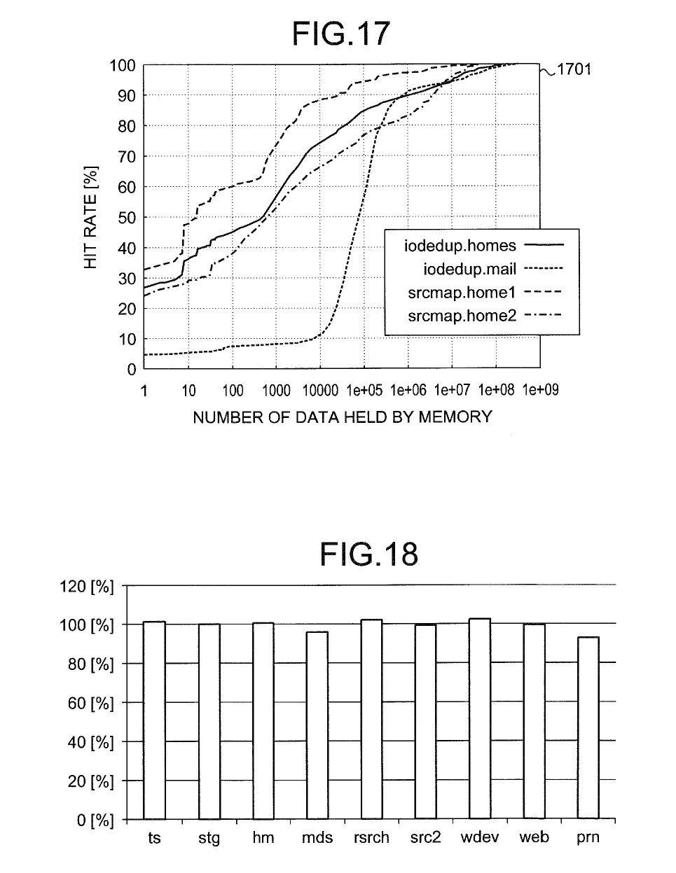

With the execution of the writing process, the storage apparatus 101 can reduce the amount of processing required for the deduplication while performing a given degree of deduplication, using the BF. A comparison of the performance according to this embodiment will be described with reference to FIGS. 17 and 18.

FIG. 17 is an explanatory diagram of the relationship between storage capacity of memory and cache hit rate. Graph 1701 depicted in FIG. 17 depicts the relationship of the storage capacity of the memory and the cache hit rate when there are one billion data, using four trace data. FIG. 17 denotes “hundred thousand” in exponential notation of “1e+05, million as “1e+06”, ten million as “1e+07”, hundred million as “1e+08”, and billion as “1e+09”. The horizontal axis of graph 1701 represents the number of data held by the memory and the vertical axis of graph 1701 represents the hit rate.

The four trace data are described below. First trace data “iodedup.homes” describes I/O patterns of the home directory. Second trace data “iodedup.mail” describes the I/O patterns of the mail server. Third trace data “srcmap.home1” describes frames and events transmitted to home1. Fourth trace data “srcmap.home2” describes the frames and the events transmitted.

As shown by graph 1701, when there are one billion data, if the memory has one million data that account for one-thousandth thereof, the storage apparatus 101 can detect about 90% of the duplication.

FIG. 18 is an explanatory diagram of a performance comparison at the time of reading. In FIG. 18, at the time of reading, the processing performance in the case of not using the MBF cache table 623 is taken as 100 [%] and the processing performance in the case of using the MBF cache table 623 is shown with respect to the trace data by nine servers. A first server is a terminal server (ts). A second server is a web STaGing (stg). A third server is a hardware monitor (hm). A fourth server is a MeDia Server (mds). A fifth server is a ReSeaRCH projects (rsrch). A sixth server is a SouRCe control (src2). A seventh server is a test Web sErVer (wdev). An eighth server is a WEB/SQL server (web). A ninth server is a PRiNt server (prn).

As depicted in FIG. 18, while the degree at which the processing performance decreases depends on the server, almost no decrease of the processing performance occurs. It is indicated that even in the server whose processing performance decreases most, the decrease of the processing performance is limited to the order of 10%.

As described above, according to the storage apparatus 101, at the time of the block writing, the MBF cache table 623 residing in the memory is searched rather than the MBF table 624 residing in the disk is searched, and if the block is not registered, the block is written. This makes it possible to reduce the load of the duplication judgment while performing the deduplication of the data to a given extent.

According to the storage apparatus 101, at the time of the block writing, the Bloom filter of the MBF cache table 623 is tested and if the block is not registered, the block is registered in the writing object MBF cache 622. Since the writing object MBF cache 622 registers the secure hash values of the blocks to be written occurring around the same time, the storage apparatus 101 increases the locality of the writing object MBF cache 622. The increase locality reduces the number of accesses of the disk and reduces the processing time required for the deduplication.

According to the storage apparatus 101, when the number of the secure hash values registered in the writing object MBF cache 622 has reached the upper limit, another Bloom filter may be used. This enables the storage apparatus 101 to suppress the false positive judgment rate.

According to the storage apparatus 101, the MBF table may be updated by using another Bloom filter. By this, since the read request or the write request is liable to happen in a short time to a new Bloom filter, the storage apparatus 101 may enhance the cache hit rate.

According to the storage apparatus 101, when the Bloom filter of the MBF cache table 623 is tested and the block to be written is registered, a block of the same value as the secure hash value of the block to be written is searched for and if detected, the block to be written need not be written. This enables the storage apparatus 101 to perform the deduplication and reduce the amount of memory of the volume 102.

According to the storage apparatus 101, when the Bloom filter of the MBF cache table 623 is tested and the block to be written is registered, the block of the same value as the secure hash value of the block to be written is searched for and if not detected, the block to be written may be written. This enables the storage apparatus 101 to hold the contents of the block normally even if the block is erroneously detected by the false positive.

According to the storage apparatus 101, when the Bloom filter of the MBF cache table 623 is tested and the block to be read is registered, the same value as the secure hash value of the block to be read may be searched for from the range of the storage area indicated by the Bloom filter. Since this narrows down the range within which to search, the storage apparatus 101 may output the object data at high speed.

According to the storage apparatus 101, when the Bloom filter of the MBF cache table 623 is tested and the block to be read is not registered, the Bloom filter of the MBF table 624 may be tested. This enables the storage apparatus 101 to output the block to be read normally even if the memory is not hit.

According to the storage apparatus 101, among the Bloom filters of the MBF table 624, the Bloom filter that is hit may be set in the MBF cache table 623. By this, since such secure hash values that will increase the locality are registered in the Bloom filters, the storage apparatus 101 can estimate that a read request to or a write request to is liable to occur in a short time and can enhance the cache hit rate.

When the MBF cache table 623 is not used, if, for example, maximum 10 [TB] area is managed by 4 [KB] block, the storage apparatus not using the MBF cache table 623 manages 25 million blocks. The storage apparatus using the two-tier MBF using 23 [bit] per block secures the memory of 2.5 [MB]×23×2 [bit]=around 14 [GB]. By contrast, in this embodiment, the size of the area and the size of the installed memory become irrelevant and even when, for example, 10 [TB] area is managed by 4 [KB] block, the storage apparatus 101 is operable even with the memory of 1 [GB] or less.

The control method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

According to one aspect of an embodiment, reductions in the load of the redundancy determination using the Bloom filter are enabled.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage apparatus comprising:
a storing unit that stores a Bloom filter in which data characteristic values are registered, the data characteristic values extracting properties of data that are stored in areas into which a storage area is divided; and
a processor that is configured to:
judge whether a first data characteristic value extracting a property of a first data that is to be written into the storage area is registered in the Bloom filter, and
write the first data into the storage area, when the first data characteristic value is not registered in the Bloom filter.

2. The storage apparatus according to claim 1, wherein the processor is further configured to:
determine based on a count of the data characteristic values already registered in the Bloom filter, whether to register the first data characteristic value into the Bloom filter when the first data characteristic value is not already registered, and
register the first data characteristic value into the Bloom filter, upon determining to register the first data characteristic value into the Bloom filter, wherein
the processor writes the first data into the areas, upon determining to register the first data characteristic value into the Bloom filter.

3. The storage apparatus according to claim 2, wherein the processor is further configured to:
acquire from the storing unit, a second Bloom filter different from the Bloom filter, upon determining to not register the first data characteristic value into the Bloom filter, wherein
the processor determines whether to register the first data characteristic value into the second Bloom filter, based on the count of the data characteristic values already registered in the second Bloom filter, upon acquiring the second Bloom filter,
the processor registers the first data characteristic value into the second Bloom filter, upon determining to register the first data characteristic value into the second Bloom filter, and
the processor writes the first data into an area that is among the areas and stores data having a data characteristic value registered in the second Bloom filter, upon determining to register the first data characteristic value into the second Bloom filter.

4. The storage apparatus according to claim 3, wherein the processor is further configured to
update contents of the storing unit, based on the acquired second Bloom filter.

5. The storage apparatus according to claim 4, wherein the processor is further configured to
detect data having the first data characteristic value among the areas, upon judging that the first data characteristic value is registered, wherein
the processor does not write the first data into the storage area, upon detecting the data having the first data characteristic value.

6. The storage apparatus according to claim 4, wherein the processor is further configured to
detect data having the first data characteristic value among the areas, upon judging that the first data characteristic value is registered, wherein
the processor writes the first data into the storage area, upon no detection of the data having the first data characteristic value.

7. The storage apparatus according to claim 4, wherein
the storing unit stores corresponding to each of the first data, a data characteristic value extracting a property of the first data that is correlated with a logical address that corresponds to the first data,
the processor is further configured to:
select from among the data characteristic values extracting the properties of each of the first data stored in the storing unit, a second data characteristic value that is correlated with the logical address of a second data to be read from the storage area;
judge whether the selected second data characteristic value is registered in the Bloom filter stored in the storing unit,
detect data having the second data characteristic value among the areas, upon judging that the second data characteristic value is registered, and
output the data having the second data characteristic value, upon detecting the data having the second data characteristic value.

8. The storage apparatus according to claim 7, wherein
the storing unit stores a plurality of Bloom filters in which the data characteristic values extracting the properties of the data that are stored in the areas are registered,
the processor is further configured to
identify among the Bloom filters, a Bloom filter in which the data having the second data characteristic value is registered, upon judging that the second data characteristic value is not registered, and
the processor detects the data having the second data characteristic value, from the area that is among the areas and stores the data having the data characteristic value registered in the identified Bloom filter.

9. The storage apparatus according to claim 8, wherein
the processor updates the contents of the storing unit, based on the Bloom filter in which the data having the identified second data characteristic value is registered.

10. A control method of a storage apparatus that has a storing unit that stores a Bloom filter in which data characteristic values are registered, the data characteristic values extracting properties of data that are stored in areas into which a storage area is divided, the control method comprising:
judging whether a first data characteristic value extracting a property of a first data that is to be written into the storage area is registered in the Bloom filter, the judging being performed by a processor of the storage apparatus, and
writing the first data into the storage area, when the first data characteristic value is not registered in the Bloom filter, the writing being performed by the processor.

11. A non-transitory, computer-readable recording medium that stores a control program of a storage apparatus that has a storing unit that stores a Bloom filter in which data characteristic values are registered, the data characteristic values extracting properties of data that are stored in areas into which a storage area is divided, the control program causes a computer to execute a process comprising:
judging whether a first data characteristic value extracting a property of a first data that is to be written into the storage area is registered in the Bloom filter, and
writing the first data into the storage area, when the first data characteristic value is not registered in the Bloom filter.
